(19) United States
(12) Patent Application Publication
(10) Pub. No.: US 2023/0003269 A1
(43) Pub. Date: Jan. 5, 2023

(54) FILTER HOUSING OF A BRAKE DUST PARTICLE FILTER FOR A BRAKE DISK ARRANGEMENT AND KIT FOR A FILTER HOUSING OF A BRAKE DUST PARTICLE FILTER

(71) Applicant: MANN+HUMMEL GMBH, Ludwigsburg (DE)

(72) Inventors: Lukas BOCK, Bietigheim-Bissingen (DE); Thomas JESSBERGER, Asperg (DE); Volker KUEMMERLING, Bietigheim-Bissingen (DE); Coskun EVLEKLI, Waiblingen (DE); Tobias WOERZ, Leutenbach (DE); Eric THEBAULT, Ludwigsburg (DE)

(21) Appl. No.: 17/894,497

(22) Filed: Aug. 24, 2022

Related U.S. Application Data
(63) Continuation of application No. PCT/EP2021/053938, filed on Feb. 18, 2021.

(30) Foreign Application Priority Data
Feb. 24, 2020 (DE) 102020104719.3

(51) Int. Cl. F16D 65/00; B01D 46/00

(52) U.S. Cl. CPC F16D 65/0031; B01D 46/0002; B01D 2279/40

(57) ABSTRACT

A circular segment-shaped filter housing of a brake dust particle filter for a brake disk arrangement has first and second spaced-apart housing side walls. A housing circumferential wall connects the first and second housing sidewalls. The first and second housing side walls and the housing circumferential wall delimit an opening for receiving a brake disk of the brake disk arrangement. Delimitation parts are arranged at an end face edge of at least one of the first and second housing side walls and at an end face edge of the housing circumferential wall. The delimitation parts are detachable and exchangeable independent of the first and second housing side walls and/or of the housing circumferential wall. The delimitation parts delimit a free cross section area of the opening. A brake dust particle filter is provided with such a filter housing. A kit for producing such a filter housing is provided.

### CROSS-REFERENCE TO RELATED APPLICATIONS

This application is a continuation application of international application No. PCT/EP2021/053938 having an international filing date of 18 Feb. 2021 and designating the United States, the international application claiming a priority date of 24 Feb. 2020 based on prior filed German patent application No. 10 2020 104 719.3, the entire contents of the aforesaid international application and the aforesaid German patent application being incorporated herein by reference.

### BACKGROUND OF THE INVENTION

The invention relates to a filter housing of a brake dust particle filter for a brake disk arrangement, with an opening for receiving a brake disk of the brake disk arrangement, wherein the opening in the filter housing is delimited by two housing side walls that are spaced apart from each other and a housing circumferential wall. The invention relates furthermore to a kit for a filter housing of a brake dust particle filter for a brake disk arrangement.

DE 10 2012 016 835 A1 discloses a brake dust particle filter for a brake disk arrangement with which abraded brake particles can be caught which are produced during a braking event by the friction between brake disk and brake pad. The brake dust particle filter comprises a circular segment-shaped filter housing with a filter medium contained therein, wherein an opening for receiving the brake disk is provided in the filter housing. In the mounted state, the brake dust particle filter is seated with the opening in the filter housing on the brake disk and surrounds the latter about an angle segment of approximately 180°.

Comparable brake dust particle filters are known from WO19/048377 A1, US 2012/067206 A1, and US 2018/031059 A1.

### SUMMARY OF THE INVENTION

The invention is based on the object of adapting a filter housing of a brake dust particle filter to different brake disks with simple constructive measures.

This object is solved according to the invention with regard to the filter housing in that, at an end face edge of at least one housing side wall and of the housing circumferential wall, delimitation parts that are detachable and exchangeable independent of the housing side wall and/or the housing circumferential wall are arranged that delimit the free cross section area of the opening.

This object is solved according to the invention with regard to the kit in that the kit comprises:

a basic housing with an opening for receiving a brake disk of the brake disk arrangement, wherein the opening is delimited by two housing side walls that are spaced apart from each other and a housing circumferential wall, and

at least one delimitation part that can be arranged at an end face edge of at least one housing side wall and/or of the housing circumferential wall and is detachable and exchangeable independent of the housing side wall and/or of the housing circumferential wall and that is configured to delimit the free cross section area of the opening.

The dependent claims provide expedient further developments, respectively.

The filter housing of a brake dust particle filter comprises a circular segment-shaped basic geometry and serves to catch brake dust in a brake disk arrangement. The filter housing extends advantageously across an angle segment of maximally 180°. In the mounted state, the filter housing is placed onto the brake disk of the brake disk arrangement so that the filter housing partially surrounds the brake disk. The filter housing forms, together with a filter element or filter medium received therein, a brake dust particle filter.

An opening is provided in the filter housing which is positioned on a side opposite to a curved housing circumferential wall and which serves for receiving the brake disk. In the mounted state, the brake disk projects past the opening into the filter housing. The opening of the filter housing is delimited by two mutually spaced apart, preferably parallel oriented, housing side walls as well as a housing circumferential wall that is configured in a circular arc shape and forms the bottom of the filter housing. In the mounted state, the radially outer edge of the brake disk is positioned adjacent to and equidistant to the inner side of the housing circumferential wall.

At the end face edge of at least one housing side wall and/or of the housing circumferential wall, at least one delimitation part is arranged that is detachable and exchangeable independent of the housing side wall and/or the housing circumferential wall and delimits the free cross section area of the opening. The delimitation part is positioned immediately at the opening in the filter housing, wherein by the selection of the size of the delimitation part the free cross section area of the opening in the filter housing can be influenced. Provided the delimitation part projects farther into the opening, the free cross section area is correspondingly reduced. Conversely, the free cross section area is larger when the exchangeable delimitation part projects less far into the opening. The delimitation part is advantageously at least embodied so wide that the end face edge of the housing side wall or of the housing circumferential wall is completely covered. Correspondingly, for a narrow embodiment the delimitation part is designed in such a way that the end face edge of the housing side wall or of the housing circumferential wall in relation to the wall thickness is covered precisely by the delimitation part.

For a better delimitation of the cross section area, at one end face edge of at least one housing side wall and of the housing circumferential wall, delimitation parts that are detachable and exchangeable independent of the housing side wall and/or the housing circumferential wall are arranged that delimit the free cross section area of the opening.

The detachable and exchangeable delimitation part enables a desired adjustment of the free cross section area of the opening into which the brake disk projects. This enables an adaptation to different brake disk diameters and/or brake disk thicknesses without modification of the filter housing. It is possible to keep the filter housing and carry out an adaptation to differently sized or thick brake disks solely by different detachable and exchangeable delimitation parts.

It is furthermore advantageous that also an abrasion and an associated thickness reduction of the brake disk can be accounted for by the exchange of one or a plurality of delimitation parts. Due to the abrasion, the thickness of the brake disk is reduced. In order to ensure that the gap between the filter housing and the brake disk does not become too large due to the abrasion, in the context of servicing an exchange of one or a plurality of delimitation parts can be performed with the goal that the gap between brake disk and filter housing assumes a desired nominal width.

It can be sufficient to arrange a detachable and exchangeable delimitation part only at the end face edge of a single housing side wall. However, it is also possible to arrange a respective detachable and exchangeable delimitation part at both housing side walls at the end face edge. Moreover, it is possible to arrange only at the end face edge of the housing circumferential wall a delimitation part so that the delimitation part forms a delimitation wall section in circumferential direction. Finally, also embodiments are conceivable with a delimitation part at the end face edge of the housing circumferential wall as well as at the end face edge of at least one housing side wall, preferably at both housing side walls.

The delimitation part at the housing side wall is located at the radially inwardly oriented end face edge of the housing side wall. The delimitation part at the housing circumferential wall is located, on the other hand, at the circumferentially oriented end face edge of the housing circumferential wall.

According to yet another advantageous embodiment that relates to delimitation parts at the housing circumferential wall as well as at at least one housing side wall, the delimitation parts at the housing circumferential wall and at the at least one housing side wall, preferably at both housing side walls, adjoin each other. In this way, it is ensured that the opening is delimited continuously at two or at three sides by delimitation parts.

According to yet another advantageous embodiment that relates to a delimitation part at the circumferentially oriented end face edge at the housing circumferential wall, this delimitation part extends in addition along the circumferentially oriented end face edge of at least of one housing side wall, preferably of both housing side walls. Correspondingly, this delimitation part has an L-shape or U-shape.

It can be expedient that the filter housing is comprised of a plurality of housing parts that are fixedly connected to each other. The filter element that forms together with the filter housing the brake dust particle filter, can comprise, like the housing part, a U-shaped cross section geometry with two filter element side walls and a filter element circumferential wall.

According to yet another advantageous embodiment, in relation to the rotational direction of the brake disk, only at the exit side a delimitation part is provided at the circumferentially oriented end face edge of the housing circumferential wall. Moreover, it can be sufficient that a delimitation part at the radially inwardly positioned end face edge of one or both housing side walls extends only across a portion of the end face edge of the housing side wall, in particular to the exit side of the rotating brake disk.

According to a further advantageous embodiment, the delimitation part is embodied as a sheet metal part. For example, the delimitation part can be screwed by screws to the housing side wall or to the housing circumferential wall. This ensures an easy fastening and an easy detachability of the delimitation part. However, the delimitation part can also be fastened by means of any other fastening method that appears suitable to a person of skill in the art.

A further aspect of the invention concerns a kit for producing a filter housing. The kit comprises a basic housing with an opening for receiving a brake disk, wherein the opening is delimited by two spaced apart housing side walls and a housing circumferential wall. Moreover, the kit comprises at least one delimitation part that can be arranged at an end face edge of at least one housing side wall and/or of the housing circumferential wall and, in the mounted state, is detachable and exchangeable independent of the housing side wall and/or the housing circumferential wall and that is configured to delimit the free cross section area of the opening.

In a preferred embodiment, the kit comprises a plurality of delimitation parts which differ in respect to their width and/or length and/or thickness and/or shape, wherein by selection of the at least one delimitation part from the plurality of delimitation parts different cross sections of the opening can be obtained.

Due to the kit according to the invention, in particular when manufacturing small production series and/or individual products, an inexpensive manufacture is enabled in that, for a plurality of application situations (different brake dimensions), only one basic housing must be made available and the adaptation to the concrete brake dimensions of the application situation is realized by determining the cross section dimensions of the opening by selecting suitable delimitation parts.

### BRIEF DESCRIPTION OF THE DRAWINGS

Further advantages and expedient embodiments can be taken from the further claims, the Figure description, and the drawings.

FIG. 1 shows in perspective view a brake dust particle filter that is placed onto a brake disk arrangement, with delimitation parts at the filter housing of the brake dust particle filter, illustrated in exploded view.

FIG. 2 shows the brake dust particle filter according to FIG. 1 with the delimitation parts fastened at the filter housing.

FIG. 3 shows the filter housing in perspective individual illustration.

FIG. 4 shows the filter housing in a view from below.

In the Figures, same components are provided with same reference characters.

### DESCRIPTION OF PREFERRED EMBODIMENTS

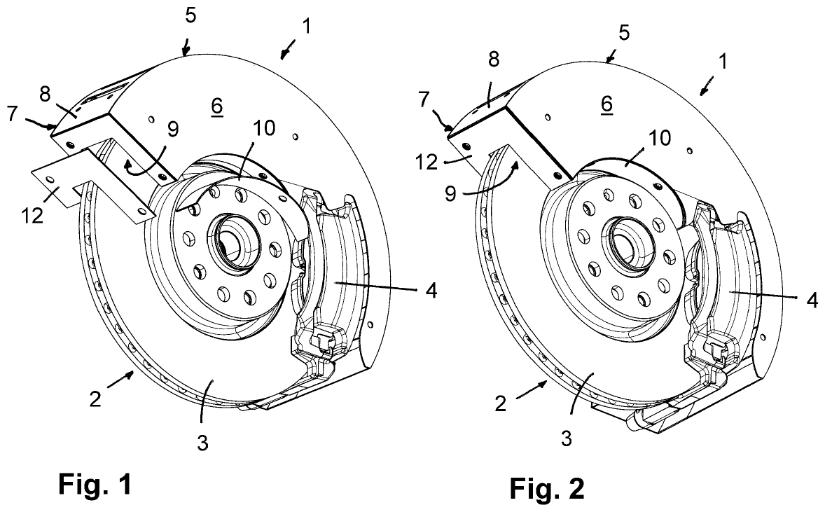

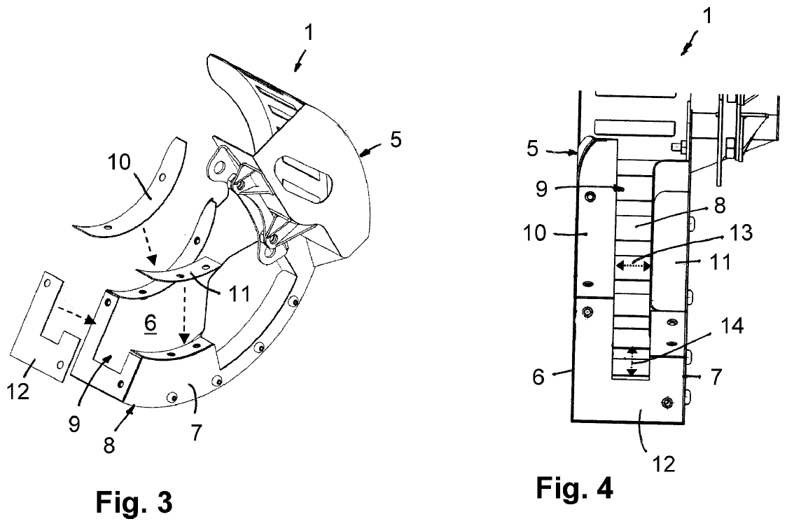

In the Figures, a brake dust particle filter 1 is illustrated that is used for a brake disk arrangement 2 (FIGS. 1, 2) in particular in motor vehicles, in order to absorb brake dust which is produced during a braking event by friction. The brake disk arrangement comprises a brake disk 3 and a brake caliper 4 that is carrier of the brake dust particle filter 1.

The brake dust particle filter 1 comprises a circular segment- or ring segment-shaped filter housing 5 that comprises a U-shaped cross section shape and receives a filter element or filter medium in which the brake dust is collected. The filter element can also have a U-shaped cross section shape corresponding to the filter housing 5. The filter housing 5 extends across an angle segment of approximately 180°.

The filter housing 5 is comprised of two housing side walls 6 and 7 which form the legs of the U-shape and are arranged spaced apart from each other and parallel. The filter housing 5 comprises moreover a housing circumferential wall 8 which forms the bottom of the U-shape and is of a curved configuration. The inner side of the housing circumferential wall 8 is positioned concentrically and equidistantly to the radial outer edge of the brake disk 3. The housing side walls 6, 7 and the housing circumferential wall 8 can form a one-piece component, wherein optionally also a multi-part filter housing is conceivable in which the housing side walls and the housing circumferential wall 8 are fixedly connected to each other.

The open radially inwardly oriented U-side in the filter housing 5 forms an opening 9 through which the brake disk 3 projects into the interior of the filter housing 5. Between the lateral surfaces and the radial outer edge of the brake disk 3 and the housing side walls 6, 7 as well as the housing circumferential wall 8, there is a respective gap that ensures a free and unhindered rotation of the brake disk 3 through the brake dust particle filter 1.

In order to ensure that the gap occupies only a defined maximum size, even when the brake disk becomes more narrow due to abrasion or differently sized or thick brake disks are installed, a delimitation part 10, 11, 12 is provided at the end face edge of both housing side walls 6, 7 and of the housing circumferential wall 8, respectively. Each delimitation part 10, 11, 12 is configured as a sheet metal part and can be screwed onto the respective end face edge of the housing side wall 6, 7 or of the housing circumferential wall 8. This makes it possible to fasten each delimitation part 10, 11, 12 detachably and thus exchangeably at the filter housing 5. Delimitation parts 10, 11, 12 can be used that are adapted to the respective brake disk 3 so that a desired gap width between the brake disk 3 and the filter housing 5 is achieved.

The delimitation parts 10, 11, 12 are arranged at the exit side—in relation to the rotational direction of the brake disk 3—of the filter housing 5. The two delimitation parts 10, 11 at the end face edge of the housing side walls 6, 7 are each formed in an arc shape and are positioned at the radially inwardly positioned end face edge of the housing side wall. The delimitation parts 10, 11 extend in the direction of the respective oppositely positioned housing side wall 6 or 7, wherein the opening 9 is formed between axially oppositely positioned inner edges of the delimitation parts 10, 11.

The delimitation part 12 is located at the circumferentially oriented end face edge of the housing circumferential wall 8 and comprises additional legs which simulate the U-shaped cross section shape of the filter housing 5 wherein each leg of the delimitation part 12 also contacts the circumferentially oriented end face edge of the housing side wall 6 and 7. The U-shaped delimitation part 12 is in itself of a planar configuration. The legs of the delimitation part 12 are embodied with different length. The delimitation part 12 forms essentially a delimitation wall of the filter housing in circumferential direction and extends advantageously substantially radially.

The two arc-shaped delimitation parts 10, 11 at the housing side walls 6, 7 adjoin immediately the U-shaped delimitation part 12 at the circumferentially oriented end face edge of the housing circumferential wall 8. This ensures a constant gap width.

The delimitation parts 10, 11 each can comprise a greater width than the thickness of the respective housing wall 6, 7, 8. In particular, the width amounts to a multiple of the thickness of the respective housing wall 6, 7, 8, preferably the width is at least 5 times, more preferred at least 10 times, larger than the thickness of the respective housing wall 6, 7, 8. Correspondingly, the delimitation parts 10, 11, 12 project inwardly past the inwardly positioned side wall of the respective housing wall 6, 7, 8 and delimit in this way the opening 9 much more than would be the case without delimitation parts 10, 11, 12.

In FIG. 4, arrows 13, 14 are shown which indicate the extension of the opening 9 in the filter housing 5 in axial direction (arrow 13) or in circumferential direction (arrow 14). Depending on the size of the delimitation parts 10, 11, 12, the free cross section area of the opening 9 is affected by the delimitation parts 10, 11, 12. Correspondingly, the gap between the inner side of the delimitation parts 10, 11, 12 and the brake disk which projects into the opening 9 changes also.

What is claimed is:

1. A circular segment-shaped filter housing of a brake dust particle filter for a brake disk arrangement, the filter housing comprising:
a first housing side wall and a second housing side wall spaced apart from each other;
a housing circumferential wall connecting the first and second housing sidewalls to each other, wherein the first and second housing side walls and the housing circumferential wall delimit an opening configured to receive a brake disk of the brake disk arrangement;
delimitation parts arranged at an end face edge of at least one of the first and second housing side walls and at an end face edge of the housing circumferential wall, wherein the delimitation parts are configured to be detachable and exchangeable independent of the first and second housing side walls and/or of the housing circumferential wall, wherein the delimitation parts delimit a free cross section area of the opening.

2. The filter housing according to claim 1, wherein a width of the delimitation parts corresponds at least to a thickness of the at least one of the first and second housing side walls and of the housing circumferential wall, respectively.

3. The filter housing according to claim 2, wherein the width of the delimitation parts amounts to a multiple of the thickness.

4. The filter housing according to claim 2, wherein the delimitation parts include a first arc-shaped delimitation part arranged at the end face edge of the first housing side wall and a second arc-shaped delimitation part arranged at the end face edge of the second housing side wall, wherein the first arc-shaped delimitation part extends toward the second housing side wall and wherein the second arc-shaped delimitation part extends toward the first housing side wall.

5. The filter housing according to claim 1, wherein the delimitation part arranged at the end face edge of the housing circumferential wall forms a delimitation wall section in circumferential direction.

6. The filter housing according to claim 5, wherein the delimitation part arranged at the end face edge of the housing circumferential wall extends additionally along the circumferentially oriented end face edge of at least one of the first and second housing side walls.

7. The filter housing according to claim 6, wherein the delimitation parts include a first arc-shaped delimitation part arranged at the end face edge of the first housing side wall and a second arc-shaped delimitation part arranged at the end face edge of the second housing side wall, wherein the first arc-shaped delimitation part extends toward the second housing side wall and wherein the second arc-shaped delimitation part extends toward the first housing side wall, wherein the first and second arc-shaped delimitation parts adjoin the delimitation part at the end face edge of the housing circumferential wall.

8. The filter housing according to claim 1, wherein the delimitation parts are sheet metal parts.

9. The filter housing according to claim 1, wherein the delimitation parts are configured to be fastened at the at least one of the first and second housing side walls and the housing circumferential wall.

10. The filter housing according to claim 9, wherein the delimitation parts are configured to be fastened by screwing at the at least one of the first and second housing side walls and the housing circumferential wall.

11. A brake dust particle filter comprising:
the circular segment-shaped filter housing according to claim 1; and
a filter element arranged in the filter housing.

12. A kit for producing a filter housing of a brake dust particle filter for a brake disk arrangement, the kit comprising:
a basic housing comprising a first housing side wall and a second housing side wall spaced apart from each other and further comprising a housing circumferential wall connecting the first and second housing sidewalls to each other, wherein the first and second housing side walls and the housing circumferential wall delimit an opening configured to receive a brake disk of the brake disk arrangement;
a delimitation part configured to be arranged at an end face edge of at least one of the first and second housing side walls and/or at an end face edge of the housing circumferential wall and configured to be detachable and exchangeable independent of the first and second housing side walls and/or of the housing circumferential wall, wherein the delimitation part is configured to delimit a free cross section area of the opening.

13. The kit according to claim 12, comprising a plurality of the delimitation parts differing in one or more properties selected from the group consisting of a width, a length, a thickness, and a shape, wherein the free cross section area of the opening is adjustable by selecting and arranging different ones of the delimitation parts from the plurality of the delimitation parts.
